(19) United States
(12) Patent Application Publication
(10) Pub. No.: US 2026/0301366 A1
(43) Pub. Date: Oct. 1, 2026

(54) INFORMATION PROCESSING APPARATUS, INFORMATION PROCESSING SYSTEM, AND INFORMATION PROCESSING METHOD

(71) Applicant: CANON KABUSHIKI KAISHA, Tokyo (JP)

(72) Inventor: KATSUYA IWATA, Kanagawa (JP)

(21) Appl. No.: 19/572,649

(22) Filed: Mar. 19, 2026

(30) Foreign Application Priority Data
Mar. 27, 2025 (JP) 2025-054462

(51) Int. Cl. G06V 10/74; G06V 10/82; G06V 20/40

(52) U.S. Cl. CPC G06V 10/761; G06V 10/82; G06V 20/41; G06V 2201/10

(57) ABSTRACT

An information processing apparatus obtains a plurality of images obtained through image capturing by a plurality of image capturing apparatuses, obtains similarity between specific scene information for specifying a specific scene from among respective scenes in the plurality of images and caption information describing a scene in each of the plurality of images, the similarity being calculated based on a vector value corresponding to the specific scene information and a vector value corresponding to the caption information, specifies a scene to be output from among the respective scenes in the plurality of images based on the similarity, and outputs the scene.

### BACKGROUND

### Field of the Technology

The present disclosure relates to a technique for specifying a desired video from a plurality of videos.

### Description of the Related Art

There have been techniques for automatically specifying a desired video from a plurality of videos. Japanese Patent Laid-Open No. 2004-312208 (hereinafter referred to as "Patent Literature 1") discloses a technique in which a plurality of videos obtained through image capturing by a plurality of image capturing apparatuses are assigned metadata in advance, and a video that matches a user's preferences is specified from the plurality of videos based on input information indicating the user's preferences and the metadata. Specifically, in the technique disclosed in Patent Literature 1 (hereinafter referred to as "the conventional technique"), the video with the highest proportion of the number of items of metadata that match the information indicating the user's preferences is specified as a video that matches the user's preferences.

The conventional technique makes a determination based on whether the information indicating the user's preferences matches the information assigned as metadata, that is, whether they exactly match each other. Therefore, if there is a fluctuation in the expression of at least one of the information indicating the user's preferences and the information assigned as metadata, any information assigned as metadata may not match the information indicating the user's preferences. As a result, there has been a problem that even videos that match the user's preferences or videos similar to those videos may not be specified as videos that match the user's preferences.

### SUMMARY

The present disclosure is directed to provide a technique that specifies a video desired by a user from a plurality of videos with high accuracy.

An information processing apparatus according to the present disclosure obtains a plurality of images obtained through image capturing by a plurality of image capturing apparatuses, obtains similarity between specific scene information for specifying a specific scene from among respective scenes in the plurality of images and caption information describing a scene in each of the plurality of images, the similarity being calculated based on a vector value corresponding to the specific scene information and a vector value corresponding to the caption information, specifies a scene to be output from among the respective scenes in the plurality of images based on the similarity, and outputs the specified scene in the image.

Features of the present disclosure will become apparent from the following description of embodiments with reference to the attached drawings. The following description of embodiments are described by way of example.

### BRIEF DESCRIPTION OF THE DRAWINGS

FIG. 1 is a block diagram showing an example of a configuration of an information processing system according to an embodiment 1.

FIG. 2A is a block diagram illustrating an example of a hardware configuration of an image capturing apparatus according to the embodiment 1, and FIG. 2B is a block diagram showing an example of a hardware configuration of an information processing apparatus according to the embodiment 1.

FIG. 3A is a block diagram showing an example of a functional configuration of the image capturing apparatus according to the embodiment 1, and FIG. 3B is a block diagram showing an example of a functional configuration of the information processing apparatus according to the embodiment 1.

FIG. 4 is a sequence diagram showing an example of a processing sequence in the information processing system according to the embodiment 1.

FIG. 5 is a diagram showing an example of a GUI screen used in a case where a user inputs specific scene information according to the embodiment 1.

FIG. 6 is a diagram showing an example of a GUI screen displayed on a display unit in each image capturing apparatus according to the embodiment 1.

FIG. 7A is a block diagram illustrating an example of a functional configuration of an image capturing apparatus according to an embodiment 2, and FIG. 7B is a block diagram illustrating an example of a functional configuration of an information processing apparatus according to the embodiment 2.

FIG. 8 is a sequence diagram showing an example of a processing sequence in an information processing system according to the embodiment 2.

### DESCRIPTION OF THE EMBODIMENTS

Hereinafter, with reference to the attached drawings, the present disclosure is explained in detail in accordance with preferred embodiments. Configurations shown in the following embodiments are merely exemplary and the present disclosure is not limited to the configurations shown schematically. Incidentally, an identical reference numeral is assigned to an identical constituent and an explanation thereof is made.

### Embodiment 1

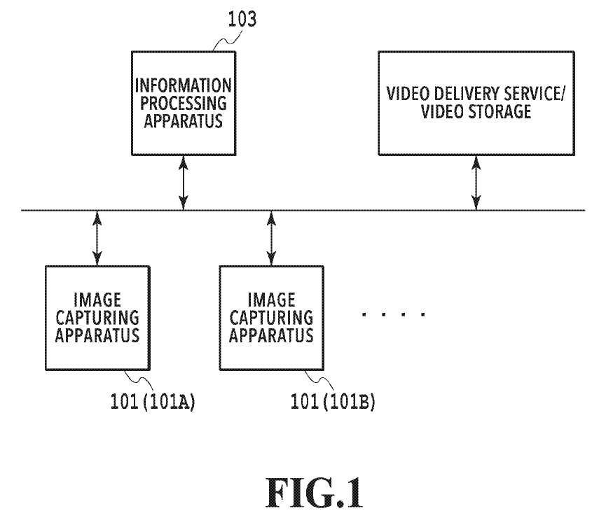

FIG. 1 is a block diagram showing an example of a configuration of an information processing system according to an embodiment 1. The information processing system includes a plurality of image capturing apparatuses 101 and an information processing apparatus 103. Although FIG. 1 shows two image capturing apparatuses as the plurality of image capturing apparatuses 101, the information processing system may include three or more image capturing apparatuses without being limited to two. In the following description, one of the plurality of image capturing apparatuses 101 is denoted as an image capturing apparatus 101A, and the other is denoted as an image capturing apparatus 101B.

The image capturing apparatuses 101A and 101B are both composed of a digital still camera, a digital video camera, or the like, and transmit data of captured images obtained by image capturing to the information processing apparatus 103 via a network. The information processing apparatus 103 receives the data of the respective captured images transmitted from the image capturing apparatuses 101A and 101B, specifies a captured image that meets a predetermined condition from the received captured images, and outputs the data of the specified captured image to a video delivery service, a video storage, or the like. The image capturing apparatuses 101A and 101B may be the same model or different models. The information processing apparatus 103 is composed of, for example, a tablet terminal, a smartphone, a personal computer (PC), a server apparatus, a server apparatus on a cloud, or the like.

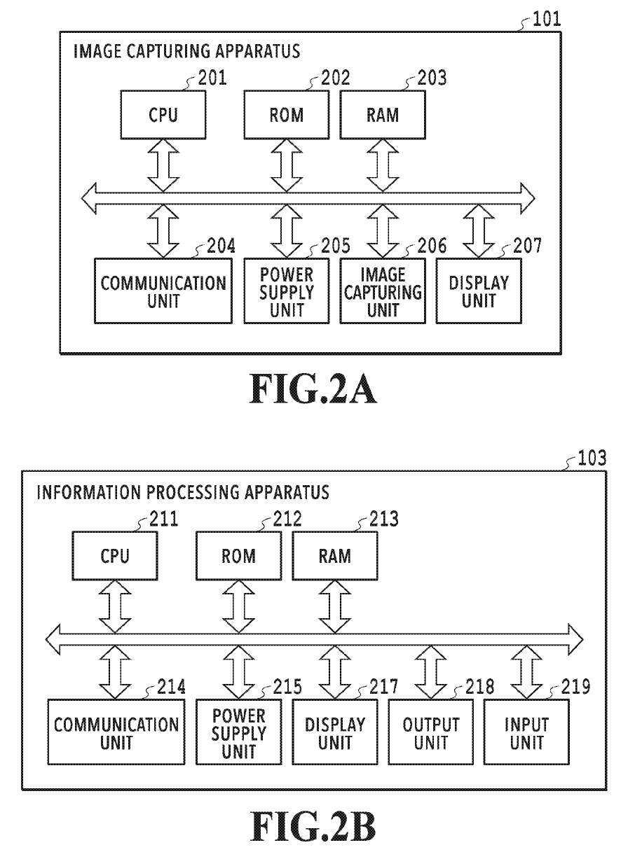

FIGS. 2A and 2B are block diagrams showing an example of hardware configurations of an image capturing apparatuses 101 and the information processing apparatus 103 according to the embodiment 1 (note: there is no “FIG. 2” reference in the drawings. The proposed amendment is to avoid an objection by the USPT0 that the Figure numbers in the Drawings and in the Specification do not match. Moving forward, please keep in mind the requirement that the Figure numbers in the Drawings and Specification must match. FIG. 2A shows an example of a hardware configuration of the image capturing apparatus 101. The image capturing apparatus 101 includes a CPU 201, a ROM 202, a RAM 203, a communication unit 204, a power supply unit 205, an image capturing unit 206, and a display unit 207. The units included in the image capturing apparatus 101 as a hardware configuration are communicatively connected to each other via a bus. The CPU 201 is composed of at least one processor or processing circuit and controls the image capturing apparatus 101. The ROM 202 is a memory that electrically erases and stores data, and stores, for example, constant data and programs to be used in computation in the CPU 201. The term “programs” as used herein refer to computer programs for executing the processes described below. The RAM 203 is used as a work area for the CPU 201, and, for example, constant data, variable data, and programs read from the ROM 202 to be used for computation in the CPU 201 are deployed on the RAM 203.

The communication unit 204 is an interface for communicating with external devices such as network equipment or USB (Universal Serial Bus) devices, and performs data communication via a network or transmits and receives data to and from external devices. Although FIG. 2A shows a LAN (Local Area Network) as an example of the network, the network is not limited thereto, but may be composed of other types of networks such as a WAN (Wide Area Network). The power supply unit 205 is a device that supplies power to the image capturing apparatus 101. The power supply unit 205 may be composed of an internal battery such as a lithium-ion battery, a removable portable battery, or the like, or may be configured to supply power based on power supplied from an AC power supply. The image capturing unit 206 includes at least one image sensor composed of a CCD (Charge Coupled Device) or CMOS (Complementary Metal Oxide Semiconductor) element or the like, converts an optical representation into an electrical signal, and outputs the electrical signal. The display unit 207 is composed of an LED (Light Emitting Diode) or LCD panel or the like, and displays a captured image, the status of the image capturing apparatus 101, or the like.

FIG. 2B shows an example of a hardware configuration of the information processing apparatus 103. The information processing apparatus 103 includes a CPU 211, a ROM 212, a RAM 213, a communication unit 214, a power supply unit 215, a display unit 217, an output unit 218, and an input unit 219. The units included in the information processing apparatus 103 as a hardware configuration are communicatively connected to each other via a bus. The CPU 211, the ROM 212, the RAM 213, the communication unit 214, the power supply unit 215, and the display unit 217 are similar hardware to the CPU 201, the ROM 202, the RAM 203, the communication unit 204, the power supply unit 205, and the display unit 207 of the image capturing apparatus 101, but are not limited to being the same type of hardware.

The output unit 218 externally outputs image signals and audio signals via SDI (Serial Digital Interface), HDMI (High-Definition Multimedia Interface (R)) (R), or the like. The output unit 208 may externally output image signals using IP (Internet Protocol) transmission over a network. The input unit 219 is composed of a keyboard and the like, and receives input of character information by a user. In a case where the information processing apparatus 103 is composed of a tablet terminal, a smartphone, or the like, the input unit 219 may be composed of a software keyboard.

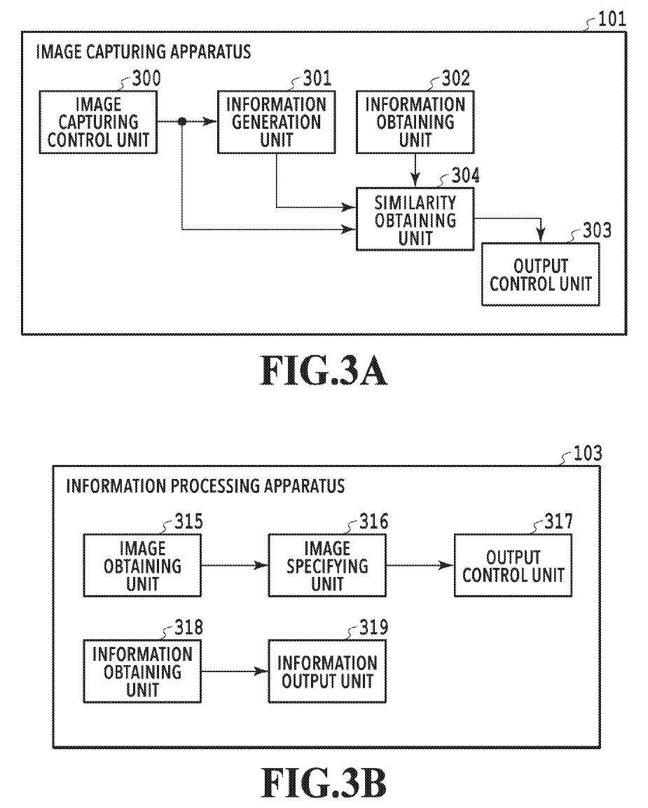

FIGS. 3A and 3B are block diagrams showing an example of functional configurations of the image capturing apparatus 101 and the information processing apparatus 103 according to the embodiment 1. FIG. 3A shows an example of a functional configuration of the image capturing apparatus 101. The image capturing apparatus 101 includes an image capturing control unit 300, an information generation unit 301, an information obtaining unit 302, an output control unit 303, and a similarity obtaining unit 304 as a functional configuration. FIG. 3B shows an example of a functional configuration of the information processing apparatus 103. The information processing apparatus 103 includes an image obtaining unit 315, an image specifying unit 316, an output control unit 317, an information obtaining unit 318, and an information output unit 319 as a functional configuration.

The processes in the units included in the image capturing apparatus 101 as a functional configuration are performed by executing a computer program using the CPU 201 and the RAM 203 of the image capturing apparatus 101. The processes may be performed by processing hardware such as an ASIC (Application Specific Integrated Circuit) of the image capturing apparatus 101. The processes in the units included in the information processing apparatus 103 as a functional configuration are performed by executing a computer program using the CPU 211 and the RAM 213 of the information processing apparatus 103. The processes may be performed by processing hardware such as an ASIC of the information processing apparatus 103. The following describes the functions of the units included in the image capturing apparatus 101 and the information processing apparatus 103 as functional configurations.

The image capturing control unit 300 controls the image capturing unit 206 to obtain an electrical signal output from the image capturing unit 206, and generates a captured image corresponding to an optical representation based on the electrical signal. As an example, the following describes the image capturing control unit 300 as generating a video stream composed of a moving image as the captured image. The information generation unit 301 generates information on an object contained as a representation in the video stream generated by the image capturing control unit 300. Here, information on an object is text information that describes the object. In the following description, the text information generated by the information generation unit 301 will be referred to as "caption information", and the process of generating caption information in the information generation unit 301 will be referred to as a "caption generation process". The caption generation process in the information generation unit 301 is performed by inferring the type, the state, or the like of an object contained in the video stream as a representation using a learned neural network obtained as a result of learning such as machine learning.

The information obtaining unit 318 obtains character information in a text format input by the user through the input unit 219 as information for specifying a specific scene from the video stream (hereinafter referred to as "specific scene information"). The information output unit 319 outputs the specific scene information obtained by the information obtaining unit 318 to all the image capturing apparatuses 101 connected to the information processing apparatus 103.

The information obtaining unit 302 obtains the specific scene information output from the information output unit 319. The specific scene information obtained by the information obtaining unit 302 is stored in the RAM 203. The similarity obtaining unit 304 calculates similarity between the caption information obtained through the caption generation process performed by the information generation unit 301 and the specific scene information obtained by the information obtaining unit 302 to obtain the similarity. The similarity obtaining unit 304 assigns the obtained similarity to the video stream generated in the image capturing control unit 300 as metadata with a timestamp in the video stream.

For example, the similarity obtaining unit 304 calculates the similarity by first inputting the specific scene information and the caption information to a learned neural network obtained as a result of learning such as machine learning to obtain vector values corresponding to the specific scene information and the caption information. Then, based on the vector value corresponding to the specific scene information and the vector value corresponding to the caption information, the similarity obtaining unit 304 calculates the cosine similarity between these vector values to obtain the similarity between the specific scene information and the caption information. The method of calculating the similarity is not limited to the method of calculating the cosine similarity between vector values.

The output control unit 303 outputs the video stream to which the similarity is assigned by the similarity obtaining unit 304 as metadata with a timestamp to the information processing apparatus 103.

The image obtaining unit 315 obtains video streams output from the output control units 303 of all the image capturing apparatuses 101 connected to the information processing apparatus 103. Specifically, for example, in the example shown in FIG. 1, the image obtaining unit 315 obtains video streams output from the output control units 303 of the image capturing apparatuses 101A and 101B. The image specifying unit 316 specifies the video stream with the highest similarity stored as metadata with a timestamp from among the video streams corresponding to the respective image capturing apparatuses 101 obtained by the image obtaining unit 315. The output control unit 317 outputs the video stream specified by the image specifying unit 316 to the video delivery service, the video storage, or the like.

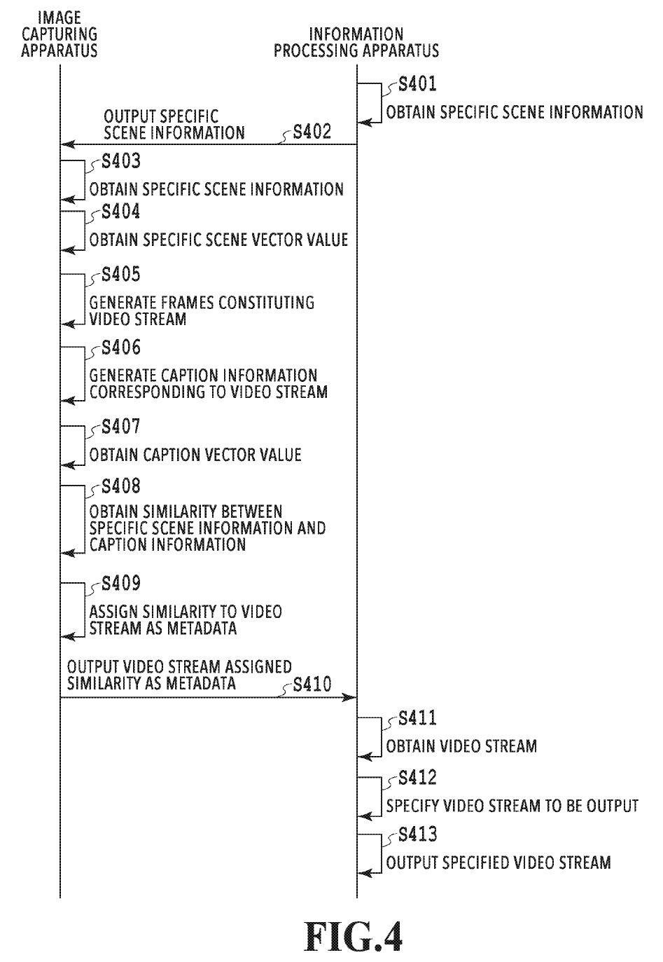

FIG. 4 is a sequence diagram showing an example of a processing sequence in the information processing system according to the embodiment 1. In the following description, the symbol "S" means a processing step (process). First, in S401, the information obtaining unit 318 in the information processing apparatus 103 obtains specific scene information.

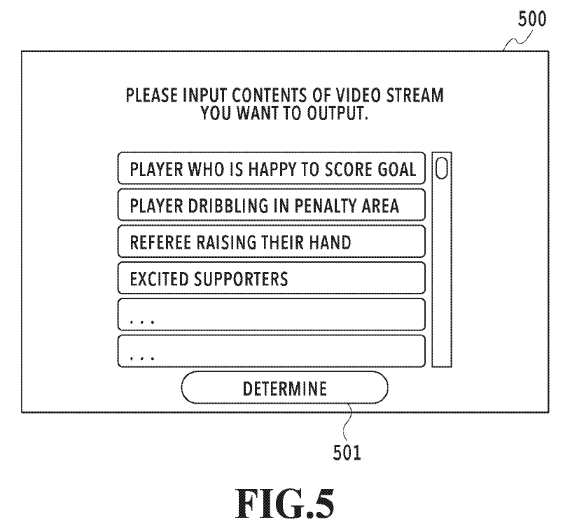

FIG. 5 is a diagram showing an example of a GUI (Graphical User Interface) screen 500 used in a case where the user inputs specific scene information according to the embodiment 1. The GUI screen 500 is displayed on, for example, the display unit 217. The user inputs a scene the user wants to output to the video delivery service, the video storage, or the like on the GUI screen 500 by describing the scene using text. For example, in a case where the information processing apparatus 103 is composed of a tablet, the user inputs text using a software keyboard by touching a text input area on the GUI screen 500. After the input of text is completed, the user presses a button 501. In a case where the button 501 is pressed, the information obtaining unit 318 obtains information of the text input on the GUI screen 500 as the specific scene information.

Returning to FIG. 4, after S401, in S402, the information output unit 319 in the information processing apparatus 103 outputs the specific scene information obtained in S401 to each image capturing apparatus 101 connected to the information processing apparatus 103. Next, in S403, the information obtaining unit 302 in each image capturing apparatus 101 obtains the specific scene information output in S402. Next, in S404, the similarity obtaining unit 304 in each image capturing apparatus 101 obtains a vector value corresponding to the specific scene information obtained in S403 (hereinafter referred to as a "specific scene vector value"). Specifically, for example, the similarity obtaining unit 304 obtains the specific scene vector value by inputting the specific scene information obtained in S403 to a learned neural network.

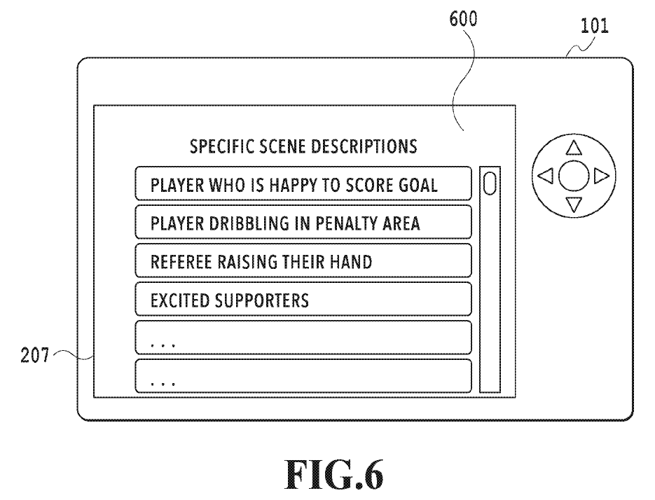

FIG. 6 is a diagram showing an example of a GUI screen 600 displayed on the display unit 207 in each image capturing apparatus 101 according to the embodiment 1. Each image capturing apparatus 101 displays the specific scene information obtained by the information obtaining unit 302 in S403 on the display unit 207, as shown on the GUI screen 600 shown as an example in FIG. 6. Displaying the specific scene information on the display unit 207 of each image capturing apparatus 101 enables an image-capturing person who performs image capturing using each image capturing apparatus 101 to perform image capturing in accordance with the user's intention while referring to the specific scene information.

Returning to FIG. 4, after S404, the information processing system repeatedly executes the processes from S405 to S413. In S405, the image capturing control unit 300 in each image capturing apparatus 101 first obtains an electrical signal output from the image capturing unit 206 by controlling the image capturing unit 206, and generates a video stream corresponding to an optical representation based on the electrical signal. Specifically, the image capturing control unit 300 generates frames constituting the video stream. Next, in S406, the information generation unit 301 in each image capturing apparatus 101 generates caption information corresponding to the video stream using the video stream generated in S405. Specifically, for example, the information generation unit 301 inputs frames constituting the video stream to the learned neural network to generate the caption information corresponding to the frames.

In S407, the similarity obtaining unit 304 in each image capturing apparatus 101 obtains a vector value corresponding to the caption information generated in S406 (hereinafter referred to as a "caption vector value"). Specifically, for example, the similarity obtaining unit 304 obtains the caption vector value by inputting the caption information generated in S406 to the learned neural network. Next, in S408, the similarity obtaining unit 304 in each image capturing apparatus 101 obtains the similarity between the specific scene information and the caption information based on the specific scene vector value obtained in S404 and the caption vector value obtained in S407. Specifically, for example, the similarity obtaining unit 304 obtains the similarity between the specific scene information and the caption information by calculating the cosine similarity between the specific scene vector value and the caption vector value. Next, in S409, the similarity obtaining unit 304 in each image capturing apparatus 101 assigns the similarity obtained in S408 to the video stream generated in S405 as metadata with a timestamp corresponding to the video stream.

In S410, the output control unit 303 in each image capturing apparatus 101 outputs the video stream after the similarity is assigned as the metadata in S409 to the information processing apparatus 103. Next, in S411, the image obtaining unit 315 in the information processing apparatus 103 obtains the video streams that are output in S410 and that are output from all the image capturing apparatuses 101 connected to the information processing apparatus 103. Next, in S412, the image specifying unit 316 in the information processing apparatus 103 specifies a video stream to be output to the video delivery service, the video storage, or the like from among the video streams corresponding to the respective image capturing apparatuses 101 obtained in S411. Specifically, the image specifying unit 316 specifies the video stream with the highest similarity assigned to the video stream as metadata with a timestamp from among the video streams corresponding to the respective image capturing apparatuses 101 obtained in S411. In S413, the output control unit 317 in the information processing apparatus 103 outputs the video stream specified in S412 to the video delivery service, the video storage, or the like.

Although this embodiment described the information processing system as repeatedly executing the processes from S405 to S413 after the process of S404, the processes in the information processing system are not limited thereto. For example, the information processing system may repeatedly execute the process of obtaining specific scene information in S401 during execution of S413, and in a case where new specific scene information is obtained in S401, execute the processes from S402 to S413 again. Such a configuration enables the information processing apparatus 103 to specify and output a video stream corresponding to the latest specific scene information obtained in S401 from among the video streams obtained in S411. In addition, for example, the information processing system may repeatedly execute the processes from S405 to S411, and repeatedly execute the processes from S412 to S413 on the video streams obtained by the information processing apparatus 103 in S411 at a predetermined cycle. In this case, the information processing system may perform the iteration processes from S405 to S411 and the iteration processes from S412 to S413 asynchronously and in parallel.

In a case where the above cycle is shortened, the output is switched to the video stream with the highest similarity for each shorter period. In a case where the cycle is lengthened, the frequency of switching video streams can be lowered. The length of the cycle may be settable by user input. The cycle t may be variable instead of constant. In a case where a trigger to switch the video stream to be output based on user input or the like is received, the processes from S412 to S413 may be executed.

As described above, in the present embodiment, each image capturing apparatus 101 is configured to assign the similarity between the respective vector values corresponding to the specific scene information and the caption information to the video stream as metadata with a timestamp. In addition, the information processing apparatus 103 is configured to specify and output a video stream corresponding to the specific scene information input by the user from among the plurality of video streams based on the similarities assigned to the video streams as metadata. The thus-configured information processing system can specify and output a video stream corresponding to the specific scene information input by the user from among the plurality of video streams with high accuracy.

Although the present embodiment described an aspect in which the specific scene information is provided by inputting information in a text format, the format of the specific scene information is not limited to this. For example, the specific scene information may be provided as information in an image format. Specifically, for example, the similarity obtaining unit 304 in each image capturing apparatus 101 obtains the similarity between the specific scene information and the video stream by calculating the similarity between an image provided as the specific scene information and the video stream. The following methods are examples of methods of calculating the similarity between the image provided as the specific scene information and the video stream.

The similarity obtaining unit 304 first inputs the image provided as the specific scene information and the frames constituting the video stream to the learned neural network to vectorize each of the image and the video stream. The similarity obtaining unit 304 then obtains the similarity between the image provided as the specific scene information and the video stream by calculating the cosine similarity between the respective vector values corresponding to the image and the video stream. The method of calculating the similarity between the image provided as the specific scene information and the video stream is not limited to this.

There may be an interest in increasing or decreasing the priority for specifying and outputting a video stream corresponding to caption information similar only to a specific item of information from among the items of specific scene information. For example, in a case where the target of image capturing is a sporting event and there is a scene where a referee raises a hand and a scene where a player is happy to score a goal, there may be an interest to more preferentially specify and output a video stream corresponding to the latter. In such a case, it is only required to configure the information processing system as follows. Specifically, for example, in a case of specifying a video stream to be output to the video delivery service, the video storage, or the like in S412, the image specifying unit 316 specifies the video stream with the maximum product of the similarity and a coefficient indicating the above priority. The coefficient indicating the above priority may be set by the user inputting a value from 0 to 1 or the like in advance for each item of specific scene information. In a case where the similarity is 0.7 and the coefficient of the priority is 0.9, the value used to specify the video stream to be output is 0.7 × 0.9 = 0.63.

### Embodiment 2

The embodiment 1 described an aspect of performing a process of calculating the similarity in each image capturing apparatus 101. The embodiment 2 will describe an aspect of performing a process of calculating the similarity in the information processing apparatus 103. Configuring the information processing apparatus 103 to perform a process of calculating the similarity eliminates the need for each image capturing apparatus 101 to have the performance necessary to calculate the similarity.

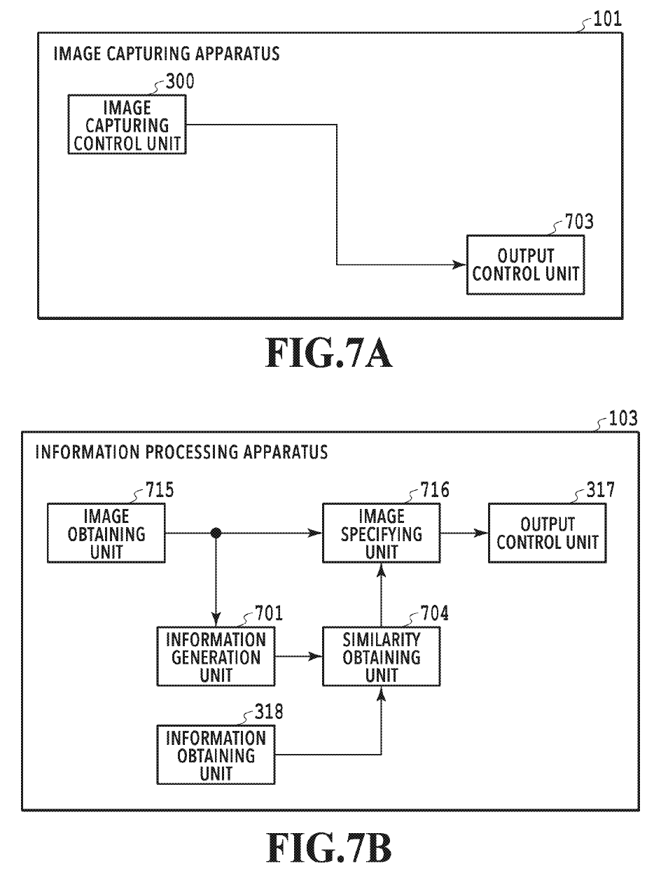

FIGS. 7A and 7B are block diagrams showing an example of functional configurations of an image capturing apparatus 101 and an information processing apparatus 103 respectively, according to the embodiment 2. Since the configuration of an information processing system according to the embodiment 2 is similar to the configuration of the information processing system according to the embodiment 1, the description thereof is omitted herein. The information processing system according to the embodiment 2 includes a plurality of image capturing apparatuses 101 and the information processing apparatus 103. Although FIG. 1 shows two image capturing apparatuses as the plurality of image capturing apparatuses 101, the information processing system may include three or more image capturing apparatuses. In addition, since the hardware configurations of the image capturing apparatus 101 and the information processing apparatus 103 according to the embodiment 2 are similar to the hardware configurations of the image capturing apparatus 101 and the information processing apparatus 103 according to the embodiment 1, the description thereof is omitted herein.

The image capturing apparatus 101 according to the embodiment 2 includes an image capturing control unit 300 and an output control unit 703 as a functional configuration. The processes in the units included in the image capturing apparatus 101 as a functional configuration are performed by executing a computer program using the CPU 201 and the RAM 203 of the image capturing apparatus 101. The processes may be performed by processing hardware such as an ASIC of the image capturing apparatus 101. Since a description of the image capturing control unit 300 has been provided above with respect to the image capturing apparatus 101 according to the embodiment 1, the description thereof is omitted herein. The output control unit 703 outputs a video stream generated by the image capturing control unit 300 to the information processing apparatus 103.

The information processing apparatus 103 according to the embodiment 2 includes an image obtaining unit 715, an image specifying unit 716, an output control unit 317, an information obtaining unit 318, an information generation unit 701, and a similarity obtaining unit 704 as a functional configuration. The processes in the units included in the information processing apparatus 103 as a functional configuration are performed by executing a computer program using the CPU 211 and the RAM 213 of the information processing apparatus 103. The processes may be performed by processing hardware such as an ASIC of the information processing apparatus 103.

The image obtaining unit 715 obtains video streams output from all the image capturing apparatuses 101 connected to the information processing apparatus 103. Since a description of the information obtaining unit 318 has been provided above with respect to the information processing apparatus 103 according to the embodiment 1, the description thereof is omitted herein. The information processing apparatus 103 according to the embodiment 1 outputs the specific scene information obtained by the information obtaining unit 318 to all the image capturing apparatuses 101 connected to the information processing apparatus 103. In the embodiment 2, however, the specific scene information obtained by the information obtaining unit 318 is instead stored in, for example, the RAM 213 of the information processing apparatus 103.

The information generation unit 701 executes the caption generation process similar to that of the information generation unit 301 according to the embodiment 1 to generate caption information that is text information on an object contained as a representation in the video stream obtained by the image obtaining unit 715. The similarity obtaining unit 704 calculates the similarity between the caption information obtained through the caption generation process performed by the information generation unit 701 and the specific scene information obtained by the information obtaining unit 318 to obtain the similarity. Since the method of calculating the similarity in the similarity obtaining unit 704 is similar to the method of calculating the similarity in the similarity obtaining unit 304 according to the embodiment 1, the description thereof is omitted herein. The image specifying unit 716 specifies the video stream with the highest similarity obtained by the similarity obtaining unit 704 from among the video streams corresponding to the respective image capturing apparatuses 101 obtained by the image obtaining unit 715. The output control unit 317 outputs the video stream specified by the image specifying unit 716 to the video delivery service, the video storage, or the like.

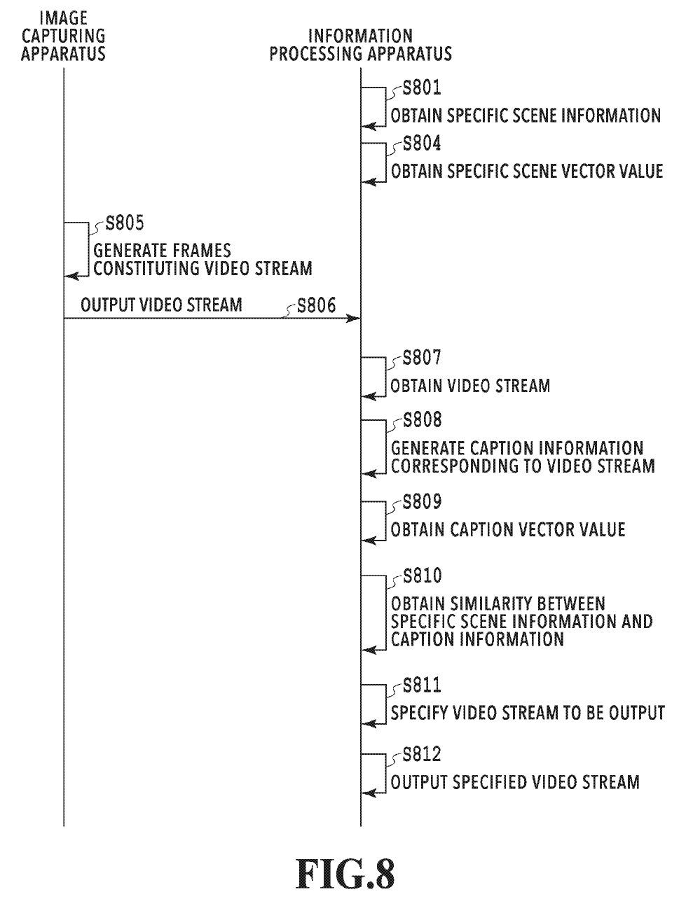

FIG. 8 is a sequence diagram showing an example of a processing sequence in the information processing system according to the embodiment 2. First, in S801, the information obtaining unit 318 in the information processing apparatus 103 obtains the specific scene information. Next, in S804, the similarity obtaining unit 704 in the information processing apparatus 103 obtains a vector value (specific scene vector value) corresponding to the specific scene information obtained in S801. Since the process of S804 is similar to the process of S404 according to the embodiment 1, the description thereof is omitted herein. After S804, the information processing system repeatedly executes the processes from S805 to S812.

In S805, the image capturing control unit 300 in each image capturing apparatus 101 first obtains an electrical signal output from the image capturing unit 206 by controlling the image capturing unit 206, and generates a video stream corresponding to an optical representation based on the electrical signal. Since the process of S805 is similar to the process of S405 according to the embodiment 1, the description thereof is omitted herein. Next, in S806, the output control unit 703 in each image capturing apparatus 101 outputs the video stream generated in S805 to the information processing apparatus 103.

In S807, the image obtaining unit 715 in the information processing apparatus 103 obtains the video streams output in S806 from all the image capturing apparatuses 101 connected to the information processing apparatus 103. Next, in S808, the information generation unit 701 in the information processing apparatus 103 generates the caption information corresponding to each video stream by executing the caption generation process on each video stream obtained in S807. Next, in S809, the similarity obtaining unit 704 in the information processing apparatus 103 obtains a vector value (caption vector value) corresponding to the caption information generated in S808. Since the process of S808 is similar to the process of S407 according to the embodiment 1, the description thereof is omitted herein. In S810, the similarity obtaining unit 704 in the information processing apparatus 103 obtains the similarity between the specific scene information and the caption information based on the specific scene vector value obtained in S804 and the caption vector value obtained in S809. Since the process of S810 is similar to the process of S408 according to the embodiment 1, the description thereof is omitted herein.

In S811, the image specifying unit 716 in the information processing apparatus 103 specifies a video stream to be output to the video delivery service, the video storage, or the like from among the video streams corresponding to the respective image capturing apparatuses 101 obtained in S807. Specifically, the image specifying unit 716 specifies the video stream with the highest similarity obtained in S810 from among the video streams corresponding to the respective image capturing apparatuses 101 obtained in S807. Next, in S812, the output control unit 317 in the information processing apparatus 103 outputs the video stream specified in S811 to the video delivery service, the video storage, or the like.

Although the present embodiment described the information processing system as repeatedly executing the processes from S805 to S812 after the process of S804, the processes in the information processing system are not limited thereto. For example, the information processing system may repeatedly execute the processes from S805 to S810, and repeatedly execute the processes from S811 to S812 on the video streams obtained by the information processing apparatus 103 in S807 at a predetermined cycle. In this case, the information processing system may perform the iteration processes from S805 to S810 and the iteration processes from S811 to S812 asynchronously and in parallel.

In a case where the above cycle is shortened, the output is switched to the video stream with the highest similarity for each shorter period. In a case where the cycle is lengthened, the frequency of switching video streams can be reduced. The length of the cycle may be settable by user input. The cycle may be variable instead of constant. In a case where a trigger to switch the video stream to be output based on user input or the like is received, the processes from S811 to S812 may be executed.

As described above, in the present embodiment, the information processing apparatus 103 is configured to obtain the similarity between the specific scene information and the caption information based on the respective vector values corresponding to the specific scene information and the caption information. In addition, in the present embodiment, the information processing apparatus 103 is configured to specify and output a video stream corresponding to the specific scene information input by the user from among the plurality of videos based on the obtained similarity. The thus-configured information processing system can specify and output a video stream corresponding to the specific scene information input by the user from among the plurality of video streams with high accuracy.

In the present embodiment, each image capturing apparatus 101 is configured to simply output a video stream without performing the process of calculating the respective vector values corresponding to the specific scene information and the caption information, the process of obtaining the similarity between the specific scene information and the caption information, and the like. The thus-configured information processing system does not need to perform the process of obtaining the similarity and the like mentioned above in each image capturing apparatus 101, thus reducing the amount of computation in each image capturing apparatus 101. As a result, each image capturing apparatus 101 does no need to have a CPU 201 with advanced computing performance, and thus the information processing system can be implemented using less expensive image capturing apparatuses 101.

### Variant 1 of Embodiment 2

Although the embodiment 2 described an aspect in which the information processing apparatus 103 generates the caption information, the present disclosure is not limited to this. Specifically, for example, each of the plurality of image capturing apparatuses 101 may have the information generation unit 301 equivalent to the information generation unit 701, and each image capturing apparatus 101 may generate the caption information. In this case, for example, each of the image capturing apparatuses 101 assigns the caption information generated by each of them to the video stream generated by each of them as metadata, and outputs the video stream. In addition, in this case, for example, the information processing apparatus 103 obtains the video stream output from each image capturing apparatus 101 and assigned the caption information as metadata, and calculates the vector value corresponding to the caption information assigned as metadata.

### Variant 2 of Embodiment 2

Although the embodiment 2 described an aspect in which the information processing apparatus 103 calculates the vector value corresponding to the caption information, the present disclosure is not limited to this. Specifically, for example, each of the plurality of image capturing apparatuses 101 may have the information generation unit 301 equivalent to the information generation unit 701 and a function equivalent to the function of calculating the caption vector value corresponding to the caption information in the similarity obtaining unit 704. In this case, for example, each of the image capturing apparatuses 101 generates the caption information corresponding to each scene in the video stream generated by each of them, and calculates the caption vector value corresponding to the generated caption information. Each of the image capturing apparatuses 101 assigns the caption vector value calculated by each of them to the video stream generated by each of them as metadata, and outputs the video stream.

In this case, for example, the information processing apparatus 103 obtains the video stream output from each image capturing apparatus 101 and assigned the caption vector value as metadata. The information processing apparatus 103 obtains the similarity between the caption information and the specific scene information using the caption vector value assigned as metadata and the specific scene vector value calculated in the information processing apparatus 103.

According to the present disclosure, a video desired by a user may be specified from among a plurality of videos with high accuracy.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-054462, filed Ma. 27, 2025, which is hereby incorporated by reference herein in its entirety.

What is claimed is:

1. An information processing apparatus, comprising:
one or more memories storing one or more programs; and
one or more hardware processors, that when executing the one or more programs, cause the information processing apparatus to:
obtain a plurality of images obtained through image capturing by a plurality of image capturing apparatuses;
obtain similarity between specific scene information for specifying a specific scene from among respective scenes in the plurality of images and caption information describing a scene in each of the plurality of images, the similarity being calculated based on a vector value corresponding to the specific scene information and a vector value corresponding to the caption information;
specify a scene to be output from among the respective scenes in the plurality of images based on the similarity; and
output the specified scene in the image.

2. The information processing apparatus according to claim 1, wherein the information processing apparatus is further caused to:
obtain the specific scene information;
output the specific scene information to an external apparatus;
obtain the plurality of images to which similarity calculated by the external apparatus using the specific scene information is assigned as metadata; and
obtain the similarity assigned to each of the plurality of images as the metadata.

3. The information processing apparatus according to claim 2, wherein the external apparatus is each of the plurality of image capturing apparatuses.

4. The information processing apparatus according to claim 1, wherein the information processing apparatus is further caused to:
obtain the specific scene information;
calculate a vector value corresponding to the specific scene information based on the specific scene information;
obtain the plurality of images to which a vector value corresponding to caption information generated by an external apparatus is assigned as metadata; and
obtain the similarity by calculating the similarity based on the calculated vector value corresponding to the specific scene information and the vector value corresponding to the caption information assigned to each of the plurality of images as the metadata.

5. The information processing apparatus according to claim 1, wherein the information processing apparatus is further caused to:
obtain the plurality of images to which caption information generated by an external apparatus is assigned as metadata;
obtain the specific scene information;
calculate a vector value corresponding to the specific scene information based on the specific scene information;
calculate a vector value corresponding to the caption information assigned to each of the plurality of images as the metadata; and
obtain the similarity by calculating the similarity based on the calculated vector value corresponding to the specific scene information and the vector value corresponding to the caption information.

6. The information processing apparatus according to claim 1, wherein the information processing apparatus is further caused to:
obtain the specific scene information;
generate the caption information corresponding to a scene in each of the plurality of images;
calculate a vector value corresponding to the specific scene information based on the specific scene information;
calculate a vector value corresponding to the caption information based on the caption information; and
obtain the similarity by calculating the similarity based on the calculated vector value corresponding to the specific scene information and the calculated vector value corresponding to the caption information.

7. The information processing apparatus according to claim 1, wherein the caption information is information obtained by inputting each of the plurality of images to a learned model obtained as a result of learning.

8. The information processing apparatus according to claim 1, wherein the vector value corresponding to the caption information is a value obtained by inputting the caption information to a learned model obtained as a result of learning.

9. The information processing apparatus according to claim 1, wherein the vector value corresponding to the specific scene information is a value obtained by inputting the specific scene information to a learned model obtained as a result of learning.

10. The information processing apparatus according to claim 1, wherein the information processing apparatus is further caused to specify a scene corresponding to the caption information high in the similarity to the specific scene information.

11. The information processing apparatus according to claim 10, wherein priority, in a case of specifying a scene, is associated with the specific scene information, and
wherein the information processing apparatus is further configured to preferentially specify a scene corresponding to the caption information high in the similarity to the specific scene information high in the associated priority.

12. The information processing apparatus according to claim 1, wherein the specific scene information is text information indicating the specific scene.

13. An information processing system, comprising:
a plurality of image capturing apparatuses; and
an information processing apparatus,
wherein at least one of the plurality of image capturing apparatuses is configured to:
obtain specific scene information for specifying a specific scene from among one or more scenes in one or more images obtained by image capturing;
generate caption information describing a scene in one of the one or more images;
calculate a vector value corresponding to the specific scene information and a vector value corresponding to the caption information;
calculate similarity between the specific scene information and the caption information based on the vector value corresponding to the specific scene information and the vector value corresponding to the caption information; and
output a metadata-assigned image to which the similarity is assigned as metadata for the image; and
wherein the information processing apparatus is configured to:
obtain a plurality of the metadata-assigned images output from the plurality of image capturing apparatuses;
specify a scene to be output from among respective scenes in the plurality of the metadata-assigned images based on the similarity assigned to each of the plurality of the metadata-assigned images as the metadata; and
output the specified scene in the metadata-assigned image.

14. A method comprising:
obtaining a plurality of images obtained through image capturing by a plurality of image capturing apparatuses;
obtaining similarity between specific scene information for specifying a specific scene from among respective scenes in the plurality of images and caption information describing a scene in each of the plurality of images, the similarity being calculated based on a vector value corresponding to the specific scene information and a vector value corresponding to the caption information;
specifying a scene to be output from among the respective scenes in the plurality of images based on the similarity; and
outputting the specified scene in the image.
